(19) United States
(12) Patent Application Publication
(10) Pub. No.: US 2026/0371339 A1
(43) Pub. Date: Nov. 19, 2026

(54) Resource-Efficient Service Period Management

(71) Applicant: Telefonaktiebolaget LM Ericsson (pub), Stockholm (SE)

(72) Inventors: Charlie Pettersson, Solna (SE); Sebastian Max, Cologne (DE); Dennis Sundman, Sollentuna (SE)

(21) Appl. No.: 19/135,600

(22) PCT Filed: Dec. 7, 2022
(86) PCT No.: PCT/EP2022/084832

§ 371 Date: Jun. 4, 2025

(51) Int. Cl. H04W 72/121; H04W 52/36; H04W 72/512; H04W 74/0833

(52) U.S. Cl. CPC H04W 72/121; H04W 52/367; H04W 72/512; H04W 74/085

(57) ABSTRACT

An access point (10) of a wireless communication system schedules a service period for transmission of first data traffic of a group of one or more wireless devices (11). Access to channel resources of the service for transmission of second data traffic may be allowed under one or more restrictions, or the first data traffic may be allowed to continue after the service period. The second data traffic may include data traffic of other wireless devices and/or data traffic of another category than the first data traffic.

### TECHNICAL FIELD

The present invention relates to methods for controlling wireless transmissions and to corresponding devices, systems, and computer programs.

### BACKGROUND

Wireless communication technologies may use licensed frequency bands and/or license-exempt frequency bands. A typical example of a wireless communication technology operating in license-exempt frequency bands is the WLAN (Wireless Local Area Network) technology, according to “IEEE Standard for Information Technology—Telecommunications and Information Exchange between Systems—Local and Metropolitan Area Networks—Specific Requirements—Part 11: Wireless LAN Medium Access Control (MAC) and Physical Layer (PHY) Specifications,” in IEEE Std 802.11-2020 (Revision of IEEE Std 802.11-2016), pp. 1-4379, 26 Feb. 2021, in the following denoted as “IEEE 802.11 standard”. The WLAN technology based on the IEEE 802.11 Standard is also referred to as “Wi-Fi”.

A recent amendment to the IEEE 802.11 standard, “IEEE Standard for Information Technology—Telecommunications and Information Exchange between Systems Local and Metropolitan Area Networks—Specific Requirements Part 11: Wireless LAN Medium Access Control (MAC) and Physical Layer (PHY) Specifications Amendment 1: Enhancements for High-Efficiency WLAN”, in the following denoted as “802.11ax amendment”, a functionality denoted as target wake-up time (TWT) was introduced. The TWT functionality allows an AP (Access Point) to schedule activity in the BSS (Basic Service Set), with the aim of reducing contention between STAs (stations). Further, the TWT functionality can be used for reducing the required amount of time that a STA utilizing a power management mode needs to be awake. The TWT functionality allows STAs to allocate and operate at nonoverlapping times and/or frequencies, and to concentrate the frame exchanges in predefined service periods (SPs).

TWT SPs may be set up by negotiation of individual TWT agreements among AP and STA(s) or by announcement of TWT SPs beacons frames transmitted by the AP. The latter variant is denoted as broadcasted TWT agreement. Broadcasted TWT agreements indicate upcoming SPs and information about member STAs that should be prepared to participate. In both cases, it is to be noted that even though an AP can force a TWT capable STA to either join a broadcast TWT schedule or set up an individual TWT agreement, the STA may immediately teardown the TWT agreement. To support such negotiations, there are several options that can be signaled between devices to reach an agreement that both sides are satisfied with. Furthermore, an SP may be terminated by an AP if the SP is no longer required for delivery of data, e.g., due to overprovisioning.

In “Standard for Information technology—Telecommunications and information exchange between systems Local and metropolitan area networks—Specific requirements—Part 11: Wireless LAN Medium Access Control (MAC) and Physical Layer (PHY) Specifications Amendment: Enhancements for Extremely High Throughput (EHT)”, in the following denoted as “802.11be amendment”, a restricted TWT (r-TWT) is proposed. The r-TWT is based on a similar framework of scheduling STAs as the TWT, but also allows an AP to prioritize certain latency sensitive traffic flows. To protect the SP from other devices trying to access the medium a scheduling AP may signal a quiet interval with the same start time as the SP with a duration of one time unit (TU) (corresponding to 1024 μs). Further, r-TWT capable non-AP STAs must ensure that their TXOP (Transmit Opportunity) ends before an upcoming SP that they are not a member of. Similarly, such non-AP STAs cannot start new data transmissions that will not finish before the SP starts. As compared to the TWT of the 802.11ax amendment, the r-TWT is based on broadcast TWT agreements for setting up periodic SPs. An AP can set up such broadcast TWT agreement by signaling a broadcast TWT information element in its beacon frame. Details concerning the possibilities of setting up a broadcast TWT agreement are specified in the IEEE 802.11 standard.

Some application scenarios involve real-time or other time-critical data traffic, which is typically subject to strict latency requirements, and such application scenarios can be expected to become even more relevant in the future. Examples for such applications are extended reality (XR) applications, augmented reality (AR), virtual reality (VR), and mixed reality (MR) applications. In these scenarios, the amount of data traffic typically varies over time and predicting the demand of data traffic may be a rather complex task. Furthermore, it is also difficult to properly set up a r-TWT for a data flow that has time-varying data traffic. In some strategies, overprovisioning may be used, and the SP is configured to be long enough to encompass possible arrival jitter of the data traffic. Such maximum SP scheduling strategies may result in a lot of unused channel resources. In other strategies, the start of the SP may be delayed to such extent that it is almost certain that the data is ready to be transmitted in the SP, even when considering the possible arrival jitter. The SP may then be configured to rather exactly match the amount of transmitted traffic data, and unused channel resources may be minimized. Such minimal SP scheduling strategies however result in an additional latency of the data traffic, thus making it more difficult to meet strict latency requirements.

The following examples further details problems which may occur with an overprovisioning strategy and with a minimal strategy in connection with the r-TWT functionality. FIG. 1A shows an example of a scenario when using a minimal SP scheduling strategy. FIG. 1B shows an example of a scenario when using a maximal SP scheduling strategy.

In the example of FIG. 1A, it is assumed that an AP transmits XR data traffic to two STAS, denoted as XR STA 1 and XR STA 2, and that the AP also needs to transmit non-time critical data traffic to the STAs. In the following, the non-time critical data traffic will also be denoted as “background data traffic”. In the minimal SP scheduling strategy of FIG. 1A, an SP is scheduled only for the amount of time needed to transmit a package of XR data and to receive an acknowledgement. The SP is scheduled in time intervals where it is almost certain that the XR data to be transmitted has arrived at the AP. Jitter may have the effect that the package of XR data arrives from up to 4 ms early to up to 4 ms late. This is accommodated by scheduling the SP 4 ms later than an estimated arrival time of the package of XR data. This has the effect that, if the package arrives 4 ms early, it transmitted only 8 ms after its arrival at the AP, i.e., with significant delay. On the other hand, the minimal strategy of FIG. 1A avoids excessive overprovisioning because the SP is just long enough to transmit the package of XR data and to receive the corresponding acknowledgement.

In the example of FIG. 1A, it is assumed that an AP transmits XR data traffic to a first STA, denoted as XR STA 1, and transmits background data traffic to a second STA, denoted as BCK STA 2. In this case, the SP is configured with the aim of reserving time for the maximum jitter plus the transmission duration of the package of XR data. Thus, the time of the arrival of the package of XR data almost certainly falls into the SP and the XR data can be transmitted immediately after arrival. In this way, delays can be minimized, however at the cost of overprovisioning: During the long SP, no other data, such as the background data, can be transmitted. Further, a quiet interval of one time unit at maximum would be present only at the start of the SP, with the risk that the quiet interval has already ended when the XR data is transmitted. The transmission of the XR data may thus be affected by interference. When considering that the jitter can be +/−4 ms, which is a realistic value for XR data traffic, the SP configured in the example of FIG. 1B needs to have a minimum duration of 8 ms, even when disregarding the actual transmission duration. When further taking into account that in a typical scenario the XR data can be expected to arrive in intervals of 1/60s=16.6667 ms, it can be seen that a maximum of only two XR STAs can be supported, with no other data traffic having a chance to be served by the AP.

Accordingly, there is a need for techniques which allow for efficiently utilizing scheduled SPs in scenarios involving different kinds of data traffic.

### SUMMARY

According to an embodiment, a method of controlling wireless transmissions in a wireless communication system is provided. According to the method, an access point (AP) of the wireless communication system schedules a service period (SP) for transmission of first data traffic of a group of one or more wireless devices. Access to channel resources of the SP for transmission of second data traffic is allowed under one or more restrictions. The second data traffic may include data traffic of other wireless devices and/or data traffic of another category than the first data traffic. Further, the AP participates in transmission of the first data traffic and/or the second data traffic in the SP.

According to a further embodiment, a method of controlling wireless transmissions in a wireless communication system is provided. According to the method, a wireless device receives, from an AP of the wireless communication system, an indication of a scheduled SP for transmission of first data traffic of a group of one or more wireless devices. Access to channel resources of the SP for transmission of second data traffic is allowed under one or more restrictions. The second data traffic may include data traffic of other wireless devices and/or data traffic of another category than the first data traffic. Further, the wireless device participates in transmission of at least a part of the first data traffic and/or the second data traffic in the SP.

According to a further embodiment, a method of controlling wireless transmissions in a wireless communication system is provided. According to the method, an AP of the wireless communication system schedules an SP for transmission of data traffic of a group of one or more wireless devices. The data traffic is allowed to continue after the SP. Further, the AP begins a transmission of the data traffic in the SP and continues the transmission after the SP.

According to a further embodiment, a method of controlling wireless transmissions in a wireless communication system is provided. According to the method, a wireless device receives, from an AP of the wireless communication system, an indication of a scheduled SP for transmission of data traffic of a group of one or more wireless devices. The data traffic is allowed to continue after the SP. Further, the wireless device begins a transmission of the data traffic in the SP and continues the transmission after the SP.

According to a further embodiment, an AP for a wireless communication system is provided. The AP is configured to schedule an SP for transmission of first data traffic of a group of one or more wireless devices. Access to channel resources of the SP for transmission of second data traffic is allowed under one or more restrictions. The second data traffic may include data traffic of other wireless devices and/or data traffic of another category than the first data traffic. Further, the AP is configured to participate in transmission of the first data traffic and/or the second data traffic in the SP.

According to a further embodiment, an AP for a wireless communication system is provided. The AP comprises at least one processor and a memory. The memory contains instructions executable by said at least one processor, whereby the AP is operative to schedule an SP for transmission of first data traffic of a group of one or more wireless devices. Access to channel resources of the SP for transmission of second data traffic is allowed under one or more restrictions. The second data traffic may include data traffic of other wireless devices and/or data traffic of another category than the first data traffic. Further, the memory contains instructions executable by said at least one processor, whereby the AP is operative to participate in transmission of the first data traffic and/or the second data traffic in the SP.

According to a further embodiment, a wireless device for a wireless communication system is provided. The wireless device is configured to receive, from an AP of the wireless communication system, an indication of a scheduled SP for transmission of first data traffic of a group of one or more wireless devices. Access to channel resources of the SP for transmission of second data traffic is allowed under one or more restrictions. The second data traffic may include data traffic of other wireless devices and/or data traffic of another category than the first data traffic. Further, the wireless device is configured to participate in transmission of at least a part of the first data traffic and/or the second data traffic in the SP.

According to a further embodiment, a wireless device for a wireless communication system is provided. The wireless device comprises at least one processor and a memory. The memory contains instructions executable by said at least one processor, whereby the wireless device is operative to receive, from an AP of the wireless communication system, an indication of a scheduled SP for transmission of first data traffic of a group of one or more wireless devices. Access to channel resources of the SP for transmission of second data traffic is allowed under one or more restrictions. The second data traffic may include data traffic of other wireless devices and/or data traffic of another category than the first data traffic. Further, the memory contains instructions executable by said at least one processor, whereby the wireless device is operative to participate in transmission of at least a part of the first data traffic and/or the second data traffic in the SP.

According to a further embodiment, an AP for a wireless communication system is provided. The AP is configured to schedule an SP for transmission of data traffic of a group of one or more wireless devices. The data traffic is allowed to continue after the SP. Further, the AP is configured to begin a transmission of the data traffic in the SP and continue the transmission after the SP.

According to a further embodiment, an AP for a wireless communication system is provided. The AP comprises at least one processor and a memory. The memory contains instructions executable by said at least one processor, whereby the AP is operative to schedule an SP for transmission of data traffic of a group of one or more wireless devices. The data traffic is allowed to continue after the SP. Further, the AP begins a transmission of the data traffic in the SP and continues the transmission after the SP.

According to a further embodiment, a wireless device for a wireless communication system is provided. The wireless device is configured to receive, from an AP of the wireless communication system, an indication of a scheduled SP for transmission of data traffic of a group of one or more wireless devices. The data traffic is allowed to continue after the SP. Further, the wireless device is configured to begin a transmission of the data traffic in the SP and continue the transmission after the SP.

According to a further embodiment, a wireless device for a wireless communication system is provided. The wireless device comprises at least one processor and a memory. The memory contains instructions executable by said at least one processor, whereby the wireless device is operative to receive, from an AP of the wireless communication system, an indication of a scheduled SP for transmission of data traffic of a group of one or more wireless devices. The data traffic is allowed to continue after the SP. Further, the wireless device is configured to begin a transmission of the data traffic in the SP and continue the transmission after the SP.

According to a further embodiment, a computer program or computer program product is provided, e.g., in the form of a non-transitory storage medium, which comprises program code to be executed by at least one processor of an AP of a wireless communication system. Execution of the program code causes the AP to schedule an SP for transmission of first data traffic of a group of one or more wireless devices. Access to channel resources of the SP for transmission of second data traffic is allowed under one or more restrictions. The second data traffic may include data traffic of other wireless devices and/or data traffic of another category than the first data traffic. Further, execution of the program code causes the AP to participate in transmission of the first data traffic and/or the second data traffic in the SP.

According to a further embodiment, a computer program or computer program product is provided, e.g., in the form of a non-transitory storage medium, which comprises program code to be executed by at least one processor of a wireless device for a wireless communication system. Execution of the program code causes the wireless device to receive, from an AP of the wireless communication system, an indication of a scheduled SP for transmission of first data traffic of a group of one or more wireless devices. Access to channel resources of the SP for transmission of second data traffic is allowed under one or more restrictions. The second data traffic may include data traffic of other wireless devices and/or data traffic of another category than the first data traffic. Further, execution of the program code causes the wireless device to participate in transmission of at least a part of the first data traffic and/or the second data traffic in the SP.

According to a further embodiment, a computer program or computer program product is provided, e.g., in the form of a non-transitory storage medium, which comprises program code to be executed by at least one processor of an AP of a wireless communication system. Execution of the program code causes the AP to schedule an SP for transmission of data traffic of a group of one or more wireless devices. The data traffic is allowed to continue after the SP. Further, execution of the program code causes the AP to begin a transmission of the data traffic in the SP and continue the transmission after the SP.

According to a further embodiment, a computer program or computer program product is provided, e.g., in the form of a non-transitory storage medium, which comprises program code to be executed by at least one processor of a wireless device for a wireless communication system. Execution of the program code causes the wireless device to receive, from an AP of the wireless communication system, an indication of a scheduled SP for transmission of data traffic of a group of one or more wireless devices. The data traffic is allowed to continue after the SP. Further, execution of the program code causes the wireless device to begin a transmission of the data traffic in the SP and continue the transmission after the SP.

Details of such embodiments and further embodiments will be apparent from the following detailed description.

### BRIEF DESCRIPTION OF THE DRAWINGS

FIGS. 1A and 1B schematically illustrate examples of scheduling an SP based on the r-TWT functionality.

FIG. 2 schematically illustrates a wireless communication system according to an embodiment.

FIG. 3A schematically illustrates an example of a variable channel access probability in accordance with an embodiment of the present disclosure.

FIG. 3B schematically illustrates a further example of a variable channel access probability in accordance with an embodiment of the present disclosure.

FIG. 4A schematically illustrates an example of scheduling an SP based on functionalities in accordance with an embodiment of the present disclosure.

FIG. 4B schematically illustrates a further example of scheduling an SP based on functionalities in accordance with an embodiment of the present disclosure.

FIG. 4C schematically illustrates a further example of scheduling an SP based on functionalities in accordance with an embodiment of the present disclosure.

FIG. 5 schematically illustrates a further example of scheduling an SP based on functionalities in accordance with an embodiment of the present disclosure.

FIG. 6 shows a flowchart for schematically illustrating a method according to an embodiment of the present disclosure.

FIG. 7 shows a flowchart for schematically illustrating a method according to a further embodiment of the present disclosure.

FIG. 8 shows a flowchart for schematically illustrating a method according to a further embodiment of the present disclosure.

FIG. 9 shows a flowchart for schematically illustrating a method according to a further embodiment of the present disclosure.

FIG. 10 schematically illustrates structures of an AP according to an embodiment of the present disclosure.

FIG. 11 schematically illustrates structures of a wireless device according to an embodiment of the present disclosure.

### DETAILED DESCRIPTION

In the following, concepts in accordance with exemplary embodiments of the invention will be explained in more detail and with reference to the accompanying drawings. The illustrated embodiments relate to controlling of wireless transmissions in a wireless communication system. The wireless communication system may be a WLAN system based on a IEEE 802.11 technology. However, it is noted that the illustrated concepts could also be applied to other wireless communication technologies, e.g., to contention-based modes of the LTE (Long Term Evolution) or NR (New Radio) technology specified by 3GPP (3^{rd} Generation Partnership Project).

In the illustrated concepts, an SP is scheduled for transmission, i.e., sending and/or receiving, of first data traffic of a group of one or more wireless devices. The first data traffic may be time-critical and be subject to a latency requirement, such as XR data traffic. The scheduled SP may however also be used for second data traffic, e.g., data traffic of a wireless device which is not member of the group and/or data traffic of another type, e.g., data traffic which is not time-critical and subject to no or a less strict latency requirement than the first data traffic. In the following, such second data traffic is also denoted as background data traffic. Access to channel resources of the SP for the second data traffic may be subject to one or more restrictions. Accordingly, adverse effects of the scheduled SP on the background data traffic may be avoided even if the SP is scheduled based on a maximum SP scheduling strategy. Accordingly, latency of the first data traffic can be guaranteed without risking excessive adverse effects on the background data traffic. The one or more restrictions may involve that the first data traffic is allowed to interrupt the second data traffic, restricting transmit power of transmissions of the second data traffic, or restricting duration of transmissions of the second data traffic. Further, the one or more restrictions may be based on configuration of a backoff counter used in channel access for transmissions of the second data traffic, based on contention window size used in channel access for transmissions of the second data traffic. The one or more restrictions may vary over the SP. In some scenarios, the SP may also allow that the first data traffic continues after the SP. In such scenarios, the SP may be scheduled very short, such that even the expected transmission of the first data traffic can not necessarily be accommodated within the SP. However, since the first data traffic is allowed to continue after the SP, channel access can be maintained until transmission of the first data traffic is finished. After that, channel resources become available for the background data traffic. Further, the SP may be scheduled with high repetition rate, so that low latency of the first data traffic can be ensured.

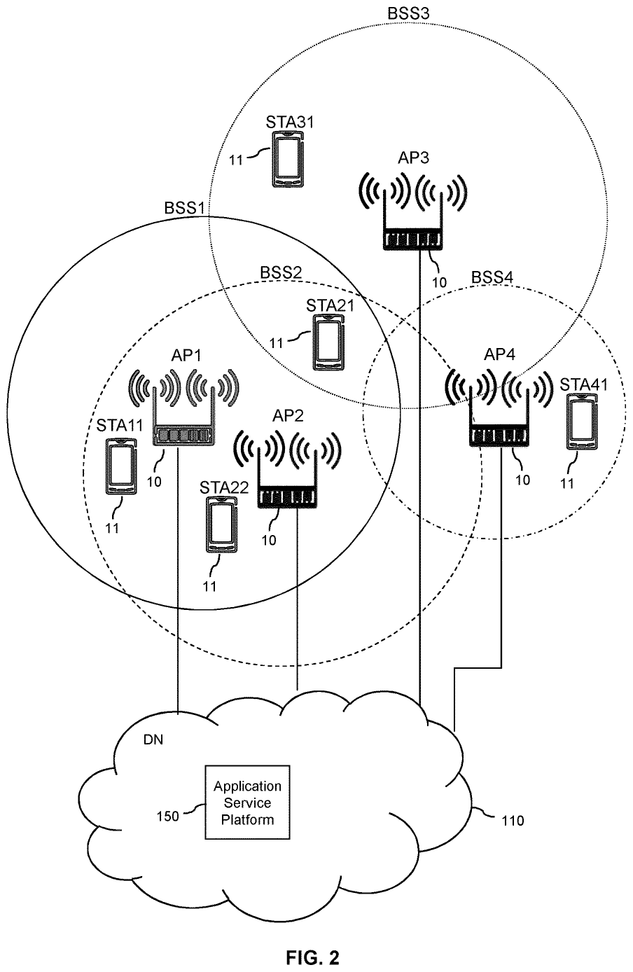

FIG. 2 illustrates an exemplary wireless communication system according to an embodiment. In the illustrated example, the wireless communication system includes multiple APs 10, in the illustrated example referred to as AP1, AP2, AP3, AP4, and multiple stations 11, in the illustrated example referred to as STA11, STA21, STA22, STA31, and STA41. STA11 is served by AP1, in a first BSS (Basic Service Set) denoted as BSS1. STA21 and STA22 are served by AP2, in a second BSS denoted as BSS2. STA31 is served by AP3, in a third BSS denoted as BSS3. STA41 is served by AP4, in a fourth BSS denoted as BSS4. The stations 11 may be non-AP STAs and correspond to various kinds of wireless devices, for example user terminals, such as mobile or stationary computing devices like smartphones, laptop computers, desktop computers, tablet computers, gaming devices, or the like. Further, the stations 11 could for example correspond to other kinds of equipment like smart home devices, printers, multimedia devices, data storage devices, or the like.

In the example of FIG. 2, each of the stations 11 may connect through a radio link to one of the APs 10. For example, depending on location or channel conditions experienced by a given station 11, the station 11 may select an appropriate AP 10 and BSS for establishing the radio link. The radio link may be based on one or more OFDM carriers from a frequency spectrum which is shared on the basis of a contention-based mechanism, e.g., an unlicensed or license-exempt band like the 2.4 GHz ISM (Industrial, Scientific and Medical) band, the 5 GHz band, the 6 GHz band, or the 60 GHz band.

Each AP 10 may provide data connectivity of the stations 11 connected to the AP 10. As further illustrated, the APs 10 may be connected to a data network (DN) 110. In this way, the APs 10 may also provide data connectivity between stations 11 connected to different APs 10. Further, the APs 10 may also provide data connectivity of the stations 11 to other entities, e.g., to one or more servers, service providers, data sources, data sinks, user terminals, or the like. Accordingly, the radio link established between a given station 11 and its serving AP 10 may be used for providing various kinds of services to the station 11, e.g., a voice service, a multimedia service, or other data service. Such services may be based on applications which are executed on the station 11 and/or on a device linked to the station 11. By way of example, FIG. 2 illustrates an application service platform 150 provided in the DN 110. The application(s) executed on the station 11 and/or on one or more other devices linked to the station 11 may use the radio link for data communication with one or more other stations 11 and/or the application service platform 150, thereby enabling utilization of the corresponding service(s) at the station 11.

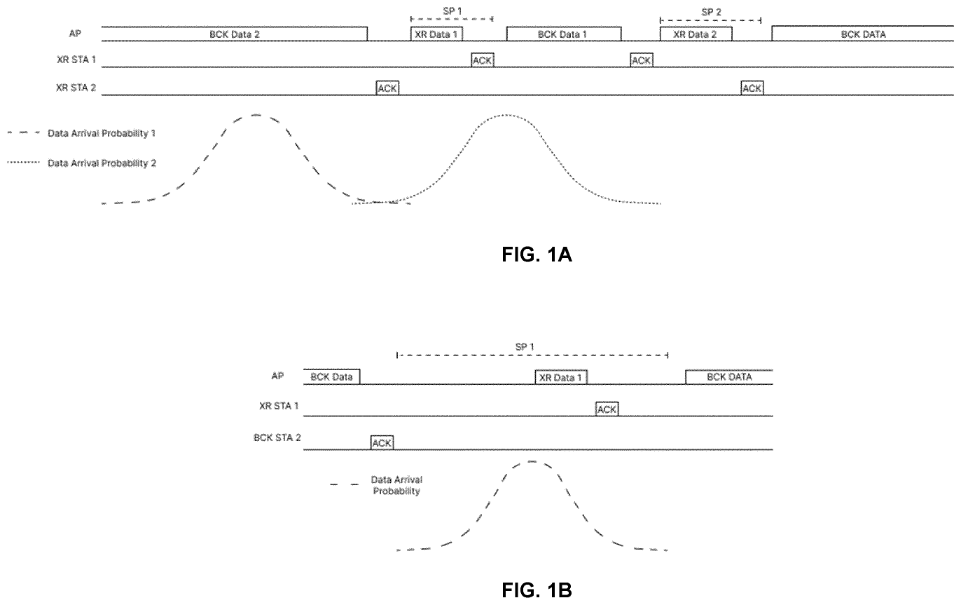

As explained in connection with FIGS. 1A and 1B, using a minimum SP scheduling strategy in connection with the existing r-TWT functionality may result excessive latency, while using a maximum SP scheduling strategy in connection with the existing r-TWT functionality may result in overprovisioning and thus inefficient spectrum usage. In the illustrated concepts, such drawbacks may be avoided by improving coexistence of data traffic which is handled based on scheduled SPs, and other data traffic without any dedicated SP. In the following, the illustrated concepts will be explained in more detail, referring to implementations which are based on modifications of the r-TWT functionality specified in the 802.11be amendment, e.g., by re-using or modifying signaling as used in the r-TWT functionality, so that, under given restrictions, channel resources of the scheduled SP are allowed to be used for background traffic. The access of the channel resources of the SP for the background data traffic may be based on a contention mechanism that avoids collision with the member data traffic or other background data traffic, e.g., a contention mechanism using a backoff counter with backoff values randomly drawn from a fixed or variable contention window. In the following such modified r-TWT functionality is also denoted as “enhanced TWT” (e-TWT). It is however noted that the illustrated concepts could also be implemented based on other kinds of mechanisms and signaling.

In an SP scheduled by the e-TWT functionality, the channel resources of the scheduled SP are thus not exclusively reserved for only member data traffic, i.e., data traffic of STAs that have setup the e-TWT agreement, and for the specific type(s) of data traffic subject to the e-TWT agreement, but also for other data traffic, i.e., background data traffic, provided that the given restrictions are met. These restrictions may include limitations to channel access and transmit parameters for the background data traffic. Such parameters may for example include: a limit of transmission power, so that the signals of the member data traffic can be reliably detected despite the presence of interfering signals from the background data traffic. Further, such parameters may include a configuration of a contention window used when contending for access to the channel resources of the SP for the member data traffic. The configuration of the contention window may include a size of the contention window, i.e., a width of a range for random drawing of a backoff value, and/or a minimum backoff counter value. A larger width of the range for random drawing of a backoff value and a higher minimum backoff value both have the effect of reducing the chances of gaining access to the channel resources of the SP for the background data traffic. Further, the channel access and transmit parameters may include maximum TXOP or PPDU (Physical Packet Data Unit) durations. Here, a shorter maximum TXOP or PPDU duration reduces the risk that the background data traffic blocks an excessive amount of the channel resources of the SP. Further, the channel access and transmit parameters may include access category (AC) restrictions, e.g., by allowing the restricted access to the channel resources only for background data traffic corresponding to a certain AC or TID (Traffic Identifier) and/or by defining the restrictions individually per TIDs or AC.

The restrictions have the effect of prioritizing the data traffic subject to the e-TWT agreement. If this data traffic is time-critical, the prioritization may in turn help to comply with latency requirements, e.g., by ensuring that the data traffic is delivered with delays that do not exceed a latency limit.

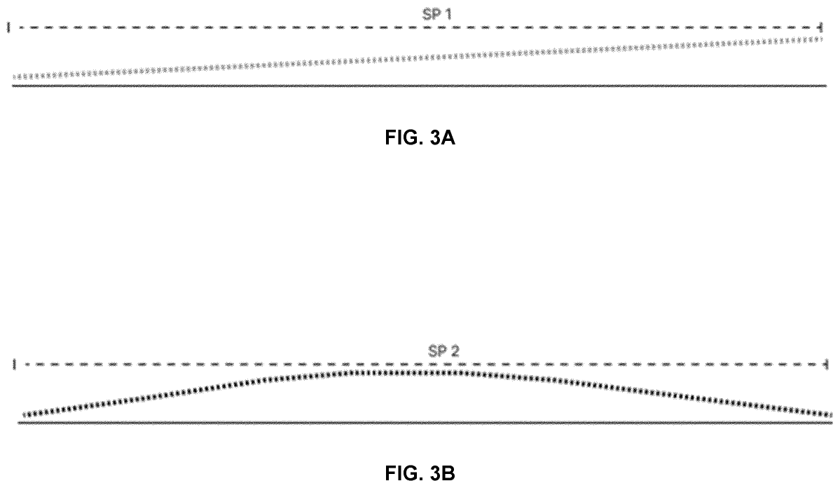

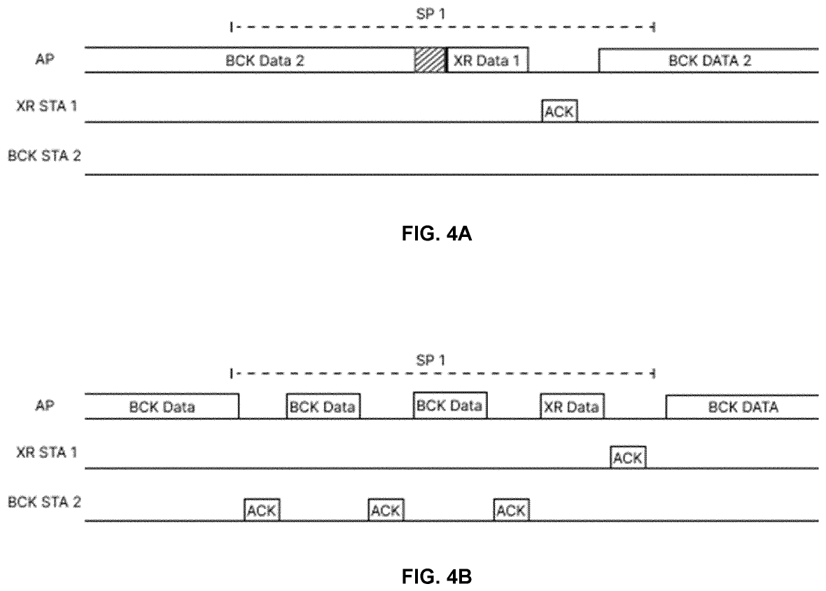

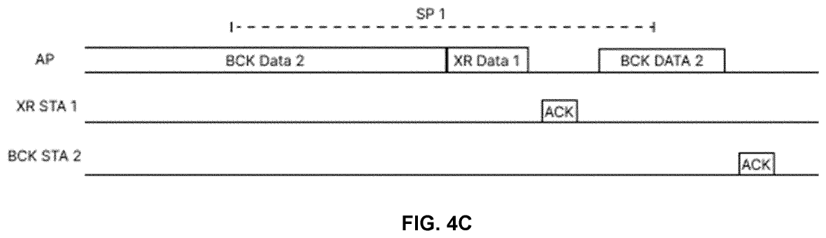

In the illustrated concepts, the restrictions applied to the background data traffic may be static over the SP. Alternatively, the restrictions could also vary over the duration of the SP. Examples of such variations of the restrictions are illustrated in FIGS. 3A and 3B. In these examples, the restrictions are assumed to be based on a channel contention difficulty value, which is illustrated by a dotted line. With higher channel contention value, the chance of gaining access to channel resources of the SP decrease. The channel contention difficulty value could for example reflect the size of the utilized contention window or a minimum value of the backoff counter. In the example of FIG. 4A, the channel contention difficulty value continuously increases from the start to the end of the scheduled SP (in FIG. 4A denoted as SP 1), e.g., according to a linear function of time. In the example of FIG. 4B, the channel contention difficulty value first increases and then decreases again over the course of the scheduled SP (in FIG. 4B denoted as SP 2), with a maximum channel contention difficulty value in the center of the SP. The increase and decrease may for example follow a Gaussian function of time. In each case, the variation of the channel contention difficulty value may be set to reflect an expected jitter pattern of the data traffic subject to the e-TWT agreement. Accordingly, the highest channel contention difficulty values may occur at the times of the highest probability of arrival of the data subject to the e-TWT agreement.

The restrictions for the background data traffic may also involve that the member data traffic is allowed to interrupt the background data traffic. Accordingly, a traffic flow of the background data traffic that uses channel resources of the SP may need to be prepared such that it can be interrupted when the channel resources are needed for the member data traffic. Such interruption of the background data traffic may occur in the form of an immediate interruption, an intermediate interruption, or a preemptive interruption. Examples involving such interruptions will now be further explained with reference to FIGS. 4A, 4B, and 4C. These examples assume that the member data traffic transmitted in an SP (denoted as “SP 1”) corresponds to XR data traffic between an AP, e.g., one of the above-mentioned APs 10, and a STA denoted as XR STA 1. The background (BCK) data traffic in turn corresponds to other data traffic between the AP and another STA denoted as BCK STA 2. These STAs may correspond to any of the above-mentioned STAs 11.

FIG. 4A illustrates an example involving an immediate interruption. In such immediate interruption, the member data traffic of XR STA 1 is transmitted immediately when it arrives and becomes ready for transmission, irrespective of channel resources of the SP being used for an ongoing transmission of the background data traffic to BCK STA 2. In this way, minimum latency can be provided for the member data traffic. No special measure is taken to attempt protecting the background data traffic. The immediately started transmission of the member data traffic may thus interfere with the ongoing transmission of the background data traffic, as illustrated by a hatched region.

In the illustration of FIG. 4A, both the member data traffic and the background data traffic are in downlink (DL) direction from the AP to the respective STA. However, other combinations of traffic directions are possible as well. For example, the background data traffic may be in uplink (UL) direction from STA to AP and the member data traffic in DL direction. In this case, the AP may ignore the UL background data traffic and just transmit the DL member data traffic. Further, the background data traffic and the member data traffic could both in UL direction, and the UL member data traffic could interrupt the UL background data traffic immediately when the UL member data traffic becomes available for transmission at XR STA 1. Further, the background data traffic could be in DL direction and the member data traffic in UL direction. However, in the latter case other ways of interruption could be preferred over an immediate interruption without any further measures. For example, the transmit power of the background data traffic could be lowered, so that signals of the UL member data traffic can be detected by the AP despite the presence of interfering signals from the DL data traffic. In addition, or as an alternative, PPDU durations of the background data traffic could be shortened to minimize the amount of time the background data traffic interfers with the member data traffic. The immediate interruption can be implemented with low complexity, it may however reduce spectral efficiency to some extent.

FIG. 4B illustrates an example involving an intermediate interruption. In the case of an intermediate interruption, the member data traffic is not allowed to interfere with the background traffic but is required to contend with the background data traffic for access to the channel resources of the SP. To improve the chances that the member data traffic gains access to the channel resources of the SP without excessive delay, the background data traffic may be restricted to use short PPDU durations. Alternatively or in addition, the size of the contention window used for the background data traffic may be set higher than the size of the contention window used for the member data traffic. Further, some TID/ACs of the background data traffic may be restricted, e.g., disallowed, in the SP. In case of collision of the member data traffic and the background data traffic, the member data traffic may be given immediate priority. As can be seen from the illustration of FIG. 4B, the background data traffic is transmitted in a scarce pattern, thus providing the member data traffic with reasonable chances to gain access to the channel resources between two transmissions of the background data traffic. The intermediate interruption may be implemented based on channel access mechanisms which are similar to the existing channel access mechanisms of the IEEE 802.11 standard. Accordingly, implementation complexity of the intermediate interruption is low.

FIG. 4C illustrates an example involving a preemptive interruption. In the case of a preemptive interruption, a mechanism is provided which allows the background data traffic to pause its data flow(s) and then later resume the transmission from where it paused. As can be seen from the illustration of FIG. 4C, the member data traffic interrupts the background data traffic immediately when the member data traffic arrives for transmission, and the background data is stopped temporarily, so that there is no interference between the member data traffic and the background data traffic. When the transmission of the member data traffic has finished, the background data traffic resumes from where it had stopped. With the preemptive interruption, both low latency of the member data traffic and good spectral efficiency may be achieved. In the case of a preemptive interruption, the preemption mechanism may be responsible for prioritizing the member data traffic over the background data traffic.

It is noted that the above principles can be applied to various combinations of traffic directions and also in scenarios where both the member data traffic and the background data traffic are transmitted to or from the same STA.

In a further variant, the illustrated concepts can be implemented by using the SP for channel reservation. In this case, the SP is configured with a very short duration, so that in the SP the AP or STA transmitting the member data traffic can gain access to the wireless channel and reserve the wireless channel, e.g., by reserving a TXOP, but without necessarily being able to finish the transmission of the member data traffic within the SP. The member data traffic is thus allowed to continue after the SP. This kind of SP is herein also denoted as “channel reservation SP”.

In the case of a channel reservation SP, there is no need to allow transmission of the background data traffic within the SP, because after the channel reservation SP has ended and the transmission of the member data traffic is finished, the wireless channel will be regularly accessible for the background data traffic. Due to the short duration of the channel reservation SP, overprovisioning can be avoided. If there is no member data traffic to transmit when the channel reservation SP comes, the amount of wasted channel resources is negligible.

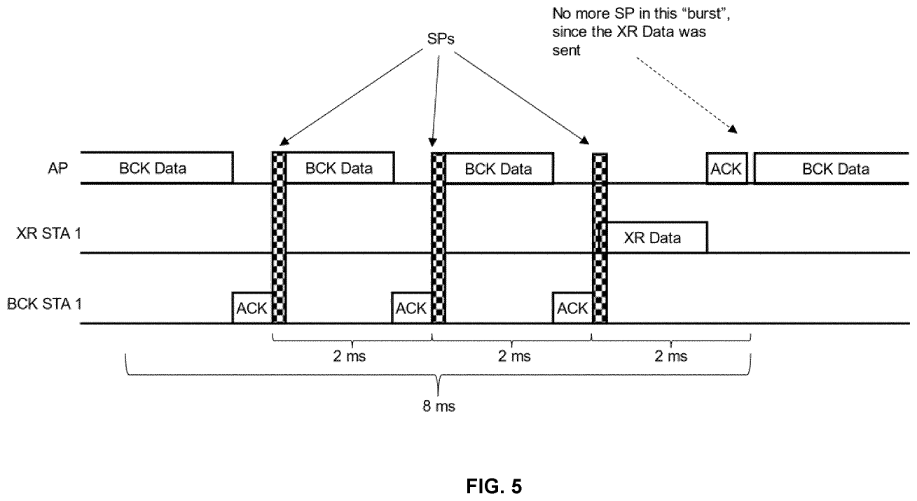

When assuming an example scenario in which the periodicity of the member data traffic is 16.7 ms, and the jitter is +−4 ms, which is not unreasonable for XR data traffic, the TWT schedule could be configured such that there is a burst of 4 channel reservation SPs with the period of 16.7 ms, with the delay between the SPs being 2 ms. FIG. 5 illustrates and example of such configuration. In FIG. 5, three of the channel reservation SPs are illustrated. The durations of the channel SPs are short, e.g., only 256 μs, or even 25 μs or less. In the illustration of FIG. 5, it can also be seen that transmission of the member data traffic starts in the third channel reservation SP and finishes some time after the third channel reservation SP. In such case, the later channel reservation SPs of the burst could also be cancelled. The channel resources released by the cancellation can then be used for the background data traffic, as illustrated in FIG. 5. Further, also intervals between two channel reservation SPs can be used for the background data traffic, as shown in FIG. 5 between the first and second channel reservation SPs, and also between the second and third channel reservation SPs.

It is noted that also the concept of the channel reservation SPs can be applied to various combinations of traffic directions and also in scenarios where both the member data traffic and the background data traffic are transmitted to or from the same STA.

It is further noted that in some scenarios, the member data traffic could also be initiated by a trigger frame from the AP. Such trigger-frame initiated data transmissions may be used for UL transmissions, but also for DL transmissions. In the illustrated concepts, such trigger a frame may be regarded as part of the member data traffic. Further, in some scenarios the scheduled SP could be terminated, e.g., in response to the member data traffic being successfully transmitted.

The SPs utilized in the illustrated concepts may be configured by using signaling which is similar to that used in the r-TWT functionality, however with the possibility of signaling some additional information, such as the limit of transmission power for the background data traffic the contention window size for the background data traffic and/or for the member data traffic, maximum PPDU duration and/or maximum TXOP duration for the background data traffic, and/or AC restrictions, such as modifications to the interframe spacing and contention window size for the different ACs per SP. Further, such signaling could be used to indicate the short duration of the channel reservation SP. The additional information may be included in further fields, information elements, or bits in the TWT fields specified in the IEEE 802.11 standard.

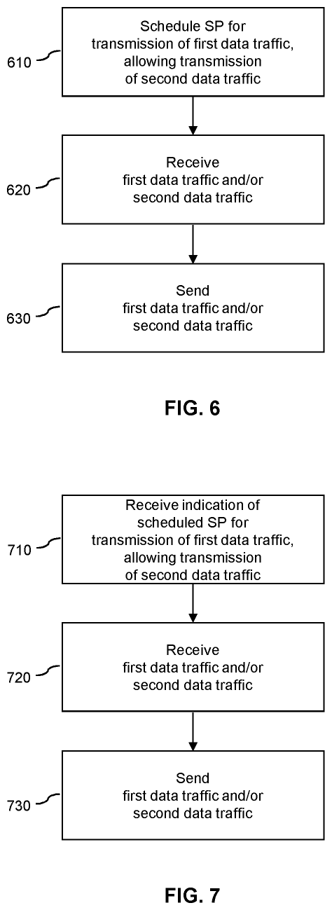

FIG. 6 shows a flowchart for illustrating a method of controlling wireless transmissions in a wireless communication system, which may be utilized for implementing the illustrated concepts. The method of FIG. 6 may be used for implementing the illustrated concepts in an AP of a wireless communication system, e.g., one of the above-mentioned APs 10. The wireless communication system may be based on a wireless local area network, WLAN, technology, e.g., according to the IEEE 802.11 standards family.

If a processor-based implementation of the AP is used, at least some of the steps of the method of FIG. 6 may be performed and/or controlled by one or more processors of the AP. Such AP may also include a memory storing program code for implementing at least some of the below described functionalities or steps of the method of FIG. 6.

At step 610, the AP schedules an SP for transmission of first data traffic of a group of one or more wireless devices. The SP is configured such that access to channel resources of the SP for transmission of second data traffic is allowed under one or more restrictions. The second data traffic may be data traffic of other wireless devices and/or of another category than the first data traffic. The first data traffic may be latency sensitive. In particular, the first data traffic may be subject to a stricter latency requirement than the second data traffic. The first data traffic may for example correspond to XR data traffic. In some scenarios, at least a part of the first data traffic is triggered by one or more trigger messages from the AP. The scheduling of the SP may involve that the AP broadcast an indication of the SP, e.g., in a beacon frame.

The one or more restrictions may involve that the first data traffic is allowed to interrupt the second data traffic. In some cases, the one or more restrictions may involve that the first data traffic is allowed to interrupt the second data traffic immediately when the first data traffic becomes available for transmission, e.g., as explained in connection with FIG. 4A. Alternatively, the one or more restrictions may involve that the first data traffic is allowed to interrupt the second data traffic in response to contention for access to the channel resources, e.g., as explained in connection with FIG. 4B. In some scenarios, the second data traffic may resume after being interrupted by the first data traffic, e.g., as explained in connection with FIG. 4C.

In addition or as an alternative, the one or more restrictions may be based on restricting transmit power of transmissions of the second data traffic. In addition or as an alternative, the one or more restrictions may be based on restricting a duration of transmissions of the second data traffic, e.g., in terms of a maximum limit for PPDU duration or a maximum limit for TXOP duration. In addition or as an alternative, the one or more restrictions may be based on configuration of a backoff counter used in channel access for transmissions of the second data traffic or on contention window size used in channel access for transmissions of the second data traffic.

The one or more restrictions may vary over a duration of the service period, e.g., as explained in connection with FIGS. 3A and 3B.

The AP then participates in transmission of the first data traffic and/or the second data traffic in the SP. As illustrated by step 620, the participation in transmission may involve that the AP receives at least a part of the first data traffic and/or at least a part of the second data traffic in the SP. Alternatively or in addition, the participation in transmission may involve that the AP sends at least a part of the first data traffic and/or at least a part of the second data traffic in the SP, as illustrated by step 630.

FIG. 7 shows a flowchart for illustrating a method of controlling wireless transmissions in a wireless communication system, which may be utilized for implementing the illustrated concepts. The method of FIG. 7 may be used for implementing the illustrated concepts in wireless device for operation in a wireless communication system, e.g., one of the above-mentioned STAs 11. The wireless communication system may be based on a wireless local area network, WLAN, technology, e.g., according to the IEEE 802.11 standards family.

If a processor-based implementation of the wireless device is used, at least some of the steps of the method of FIG. 7 may be performed and/or controlled by one or more processors of the wireless device. Such wireless device may also include a memory storing program code for implementing at least some of the below described functionalities or steps of the method of FIG. 7.

At step 710, the wireless device receives an indication of a scheduled SP for transmission of first data traffic of a group of one or more wireless devices. The SP is configured such that access to channel resources of the SP for transmission of second data traffic is allowed under one or more restrictions. The second data traffic may be data traffic of other wireless devices and/or of another category than the first data traffic. The first data traffic may be latency sensitive. In particular, the first data traffic may be subject to a stricter latency requirement than the second data traffic. The first data traffic may for example correspond to XR data traffic. In some scenarios, at least a part of the first data traffic is triggered by one or more trigger messages from the AP. The indication may be received in broadcast signaling, e.g., in a beacon frame.

The one or more restrictions may involve that the first data traffic is allowed to interrupt the second data traffic. In some cases, the one or more restrictions may involve that the first data traffic is allowed to interrupt the second data traffic immediately when the first data traffic becomes available for transmission, e.g., as explained in connection with FIG. 4A. Alternatively, the one or more restrictions may involve that the first data traffic is allowed to interrupt the second data traffic in response to contention for access to the channel resources, e.g., as explained in connection with FIG. 4B. In some scenarios, the second data traffic may resume after being interrupted by the first data traffic, e.g., as explained in connection with FIG. 4C.

In addition or as an alternative, the one or more restrictions may be based on restricting transmit power of transmissions of the second data traffic. In addition or as an alternative, the one or more restrictions may be based on restricting a duration of transmissions of the second data traffic, e.g., in terms of a maximum limit for PPDU duration or a maximum limit for TXOP duration. In addition or as an alternative, the one or more restrictions may be based on configuration of a backoff counter used in channel access for transmissions of the second data traffic or on contention window size used in channel access for transmissions of the second data traffic.

The one or more restrictions may vary over a duration of the service period, e.g., as explained in connection with FIGS. 3A and 3B.

The wireless device then participates in transmission of the first data traffic and/or the second data traffic in the SP. As illustrated by step 720, the participation in transmission may involve that the wireless device receives at least a part of the first data traffic and/or at least a part of the second data traffic in the SP. Alternatively or in addition, the participation in transmission may involve that the AP sends at least a part of the first data traffic and/or at least a part of the second data traffic in the SP, as illustrated by step 730.

FIG. 8 shows a flowchart for illustrating a method of controlling wireless transmissions in a wireless communication system, which may be utilized for implementing the illustrated concepts. The method of FIG. 8 may be used for implementing the illustrated concepts in an AP of a wireless communication system, e.g., one of the above-mentioned APs 10. The wireless communication system may be based on a wireless local area network, WLAN, technology, e.g., according to the IEEE 802.11 standards family.

If a processor-based implementation of the AP is used, at least some of the steps of the method of FIG. 8 may be performed and/or controlled by one or more processors of the AP. Such AP may also include a memory storing program code for implementing at least some of the below described functionalities or steps of the method of FIG. 8.

At step 810, the AP schedules an SP for transmission of data traffic of a group of one or more wireless devices. The SP is configured such that the data traffic is allowed to continue after the SP. The data traffic may be latency sensitive. The data traffic may for example correspond to XR data traffic. In some scenarios, at least a part of the data traffic is triggered by one or more trigger messages from the AP. The scheduling of the SP may involve that the AP broadcast an indication of the SP, e.g., in a beacon frame.

The SP may be shorter than a minimum duration of a transmission of the data traffic, e.g., shorter than a minimum duration of a PPDU or of a TXOP. The SP may have a duration of 256 μs or less. In some scenarios, the SP may have a duration of 25 μs or less.

The AP then begins a transmission of the data traffic in the SP, as illustrated by step 820. This may involve that the AP begins receiving at least a part of the data traffic in the SP and/or begins sending at least a part of the data traffic in the SP. Further, the AP continues the transmission after the AP, as illustrated by step 830. This may involve that the AP continues receiving at least a part of the data traffic in the SP and/or continues sending at least a part of the data traffic in the SP.

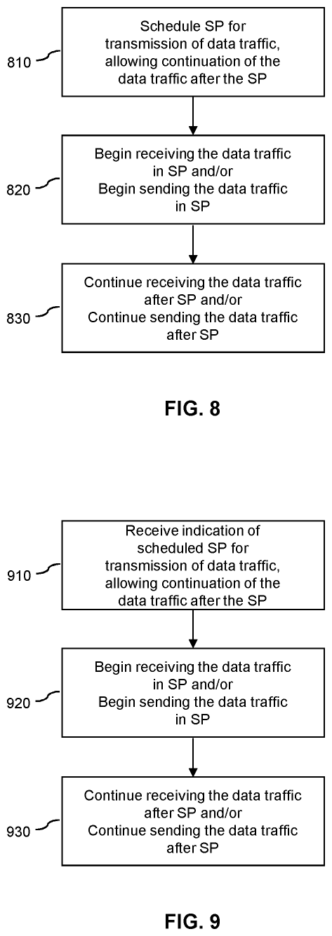

FIG. 9 shows a flowchart for illustrating a method of controlling wireless transmissions in a wireless communication system, which may be utilized for implementing the illustrated concepts. The method of FIG. 9 may be used for implementing the illustrated concepts in wireless device for operation in a wireless communication system, e.g., one of the above-mentioned STAs 11. The wireless communication system may be based on a wireless local area network, WLAN, technology, e.g., according to the IEEE 802.11 standards family.

If a processor-based implementation of the wireless device is used, at least some of the steps of the method of FIG. 9 may be performed and/or controlled by one or more processors of the wireless device. Such wireless device may also include a memory storing program code for implementing at least some of the below described functionalities or steps of the method of FIG. 9.

At step 910, the wireless device receives an indication of a scheduled SP for transmission of data traffic of a group of one or more wireless devices. The SP is configured such that the data traffic is allowed to continue after the SP. The data traffic may be latency sensitive. The data traffic may for example correspond to XR data traffic. In some scenarios, at least a part of the data traffic is triggered by one or more trigger messages from the AP. The indication may be received in broadcast signaling, e.g., in a beacon frame.

The SP may be shorter than a minimum duration of a transmission of the data traffic, e.g., shorter than a minimum duration of a PPDU or of a TXOP. The SP may have a duration of 256 μs or less. In some scenarios, the SP may have a duration of 25 μs or less.

The wireless device then begins a transmission of the data traffic in the SP, as illustrated by step 920. This may involve that the wireless device begins receiving at least a part of the data traffic in the SP and/or begins sending at least a part of the data traffic in the SP. Further, the wireless device continues the transmission after the AP, as illustrated by step 930. This may involve that the wireless device continues receiving at least a part of the data traffic in the SP and/or continues sending at least a part of the data traffic in the SP.

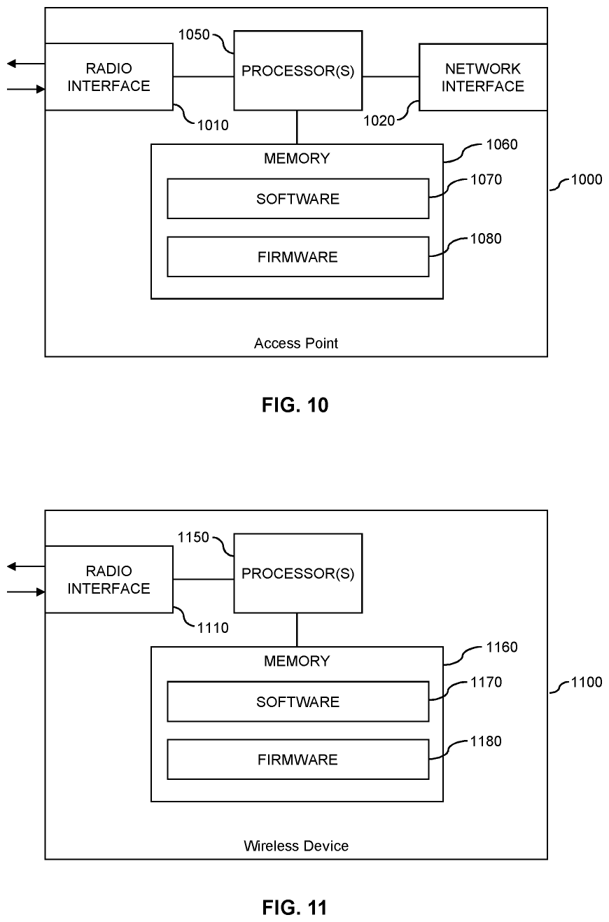

FIG. 10 illustrates a processor-based implementation of an AP 1000. The structures as illustrated in FIG. 10 may be used for implementing the above-described concepts. The AP 1000 may for example correspond to one of above-mentioned APs 10.

As illustrated, the AP 1000 includes a radio interface 1010. The radio interface 1010 may for example be based on a WLAN technology, e.g., according to an IEEE 802.11 family standard. However, other wireless technologies could be supported as well, e.g., the LTE technology or the NR technology. Further, the AP 1000 is provided with a network interface 1020 for connecting to a data network, e.g., using a wire-based connection.

Further, the AP 1000 may include one or more processors 1050 coupled to the interfaces 1010, 1020, and a memory 1060 coupled to the processor(s) 1050. By way of example, the interfaces 1010, 1020, the processor(s) 1050, and the memory 1060 could be coupled by one or more internal bus systems of the AP 1000. The memory 1060 may include a Read-Only-Memory (ROM), e.g., a flash ROM, a Random Access Memory (RAM), e.g., a Dynamic RAM (DRAM) or Static RAM (SRAM), a mass storage, e.g., a hard disk or solid state disk, or the like. As illustrated, the memory 1060 may include software 1070 and/or firmware 1080. The memory 1060 may include suitably configured program code to be executed by the processor(s) 1050 so as to implement the above-described functionalities for controlling wireless transmissions, such as explained in connection with the method of FIG. 6 or the method of FIG. 8.

It is to be understood that the structures as illustrated in FIG. 10 are merely schematic and that the AP 1000 may actually include further components which, for the sake of clarity, have not been illustrated, e.g., further interfaces or further processors. Also, it is to be understood that the memory 1060 may include further program code for implementing known functionalities of an AP in an IEEE 802.11 standard compliant technology. According to some embodiments, also a computer program may be provided for implementing functionalities of the AP 1000, e.g., in the form of a physical medium storing the program code and/or other data to be stored in the memory 1060 or by making the program code available for download or by streaming.

FIG. 11 illustrates a processor-based implementation of wireless device 1100. The structures as illustrated in FIG. 11 may be used for implementing the above-described concepts. The wireless device 1100 may for example correspond to one of above-mentioned STAs 11.

As illustrated, the wireless device 1100 includes a radio interface 1110. The radio interface 1110 may for example be based on a WLAN technology, e.g., according to an IEEE 802.11 family standard. However, other wireless technologies could be supported as well, e.g., the LTE technology or the NR technology.

Further, the wireless device 1100 may include one or more processors 1150 coupled to the radio interface 1110 and a memory 1160 coupled to the processor(s) 1150. By way of example, the radio interface 1110, the processor(s) 1150, and the memory 1160 could be coupled by one or more internal bus systems of the wireless device 1100. The memory 1160 may include a ROM, e.g., a flash ROM, a RAM, e.g., a DRAM or SRAM, a mass storage, e.g., a hard disk or solid state disk, or the like. As illustrated, the memory 1160 may include software 1170 and/or firmware 1180. The memory 1160 may include suitably configured program code to be executed by the processor(s) 1150 so as to implement the above-described functionalities for controlling wireless transmissions, such as explained in connection with the method of FIG. 7 or the method of FIG. 9.

It is to be understood that the structures as illustrated in FIG. 11 are merely schematic and that the wireless device 1100 may actually include further components which, for the sake of clarity, have not been illustrated, e.g., further interfaces or further processors. Also, it is to be understood that the memory 1160 may include further program code for implementing known functionalities of STA in an IEEE 802.11 standard compliant technology. According to some embodiments, also a computer program may be provided for implementing functionalities of the wireless device 1100, e.g., in the form of a physical medium storing the program code and/or other data to be stored in the memory 1160 or by making the program code available for download or by streaming.

As can be seen, the concepts as described above may be used for using SPs in a resource efficient manner, while at the same time taking into account requirements of latency-sensitive data traffic, such as XR data traffic. The concepts may be implemented based on existing TWT mechanisms, however providing an improved balance of spectral efficiency and minimized latency. As a result, an AP may be able to more efficiently serve low-latency applications simultaneously with other applications which are less time-critical.

It is to be understood that the examples and embodiments as explained above are merely illustrative and susceptible to various modifications. For example, the illustrated concepts may be applied in connection with various kinds of wireless technologies, without limitation to WLAN technologies. Further, the illustrated concepts may be applied with respect to various categories of data traffic, without limitation to the above-mentioned example of XR data traffic. Moreover, it is to be understood that the above concepts may be implemented by using correspondingly designed software to be executed by one or more processors of an existing device or apparatus, or by using dedicated device hardware. Further, it should be noted that the illustrated apparatuses or devices may each be implemented as a single device or as a system of multiple interacting devices or modules.

1-56. (canceled)

57. A method of controlling wireless transmissions in a wireless communication system, the method comprising:
an access point of the wireless communication system scheduling a service period for transmission of first data traffic of a group of one or more wireless devices, wherein access to channel resources of the service period for transmission of second data traffic of other wireless devices and/or of another category than the first data traffic is allowed under one or more restrictions comprising that the first data traffic is allowed to interrupt the second data traffic; and
the access point participating in transmission of the first data traffic and/or the second data traffic in the service period.

58. The method of claim 57,
wherein the first data traffic is subject to a stricter latency requirement than the second data traffic.

59. The method of claim 57,
wherein the one or more restrictions comprise that the first data traffic is allowed to interrupt the second data traffic immediately when the first data traffic becomes available for transmission.

60. The method of claim 57,
wherein the one or more restrictions comprise that the first data traffic is allowed to interrupt the second data traffic in response to contention for access to the channel resources.

61. The method of claim 57, wherein the one or more restrictions are based on at least one of the following:
restricting transmit power of transmissions of the second data traffic;
restricting duration of transmissions of the second data traffic;
configuration of a backoff counter used in channel access for transmissions of the second data traffic; and
contention window size used in channel access for transmissions of the second data traffic.

62. The method of claim 57, wherein the one or more restrictions vary over a duration of the service period.

63. The method of claim 57, wherein at least a part of the first data traffic is triggered by one or more trigger messages from the access point.

64. An access point, comprising:
at least one processor, and
a memory containing program code executable by the at least one processor,
wherein the at least one processor, memory, and program code are configured so that execution of the program code by the at least one processor causes the access point to perform the method of claim 57.

65. A method of controlling wireless transmissions in a wireless communication system, the method comprising:
a wireless device receiving, from an access point of the wireless communication system, an indication of a scheduled service period for transmission of first data traffic of a group of one or more wireless devices, wherein access to channel resources of the service period for transmission of second data traffic of other wireless devices and/or of another category than the first data traffic is allowed under one or more restrictions comprising that the first data traffic is allowed to interrupt the second data traffic; and
the wireless device participating in transmission of at least a part of the first data traffic and/or the second data traffic in the service period.

66. The method of claim 65,
wherein the first data traffic is subject to a stricter latency requirement than the second data traffic.

67. The method of claim 65,
wherein the one or more restrictions comprise that the first data traffic is allowed to interrupt the second data traffic immediately when the first data traffic becomes available for transmission or that the first data traffic is allowed to interrupt the second data traffic in response to contending for access to the channel resources.

68. The method of claim 65, wherein the one or more restrictions are based on one or more of the following:
restricting a transmit power of transmissions of the second data traffic;
restricting a duration of transmissions of the second data traffic;
configuration of a backoff counter used in channel access for transmissions of the second data traffic; and
a contention window size used in channel access for transmissions of the second data traffic.

69. The method of claim 65, wherein the one or more restrictions vary over the duration of the service period.

70. A wireless device, comprising:
at least one processor, and
a memory containing program code executable by the at least one processor,
wherein the at least one processor, memory, and program code are configured so that execution of the program code by the at least one processor causes the wireless device to perform the method of claim 65.

71. A method of controlling wireless transmissions in a wireless communication system, the method comprising:
an access point of the wireless communication system scheduling a service period for transmission of data traffic of a group of one or more wireless devices, wherein the service period has a duration of 256 μs or less and the data traffic is allowed to continue after the service period; and
the access point beginning a transmission of the data traffic in the service period and continuing the transmission after the service period.

72. The method of claim 71, wherein the service period is shorter than a minimum duration of a transmission of the data traffic.

73. An access point, comprising:
at least one processor, and
a memory containing program code executable by the at least one processor,
wherein the at least one processor, memory, and program code are configured so that execution of the program code by the at least one processor causes the access point to perform the method of claim 71.

74. A method of controlling wireless transmissions in a wireless communication system, the method comprising:
a wireless device receiving, from an access point of the wireless communication system, an indication of a scheduled service period for transmission of data traffic of a group of one or more wireless devices, wherein the service period has a duration of 256 μs or less and the data traffic is allowed to continue after the service period; and
the wireless device beginning a transmission of the data traffic in the service period and continuing the transmission after the service period.

75. The method of claim 74,
wherein the service period is shorter than a minimum duration of a transmission of the data traffic.

76. A wireless device, comprising:
at least one processor, and
a memory containing program code executable by the at least one processor,
wherein the at least one processor, memory, and program code are configured so that execution of the program code by the at least one processor causes the wireless device to perform the method of claim 74.
